(19) United States
(12) Patent Application Publication
(10) Pub. No.: US 2026/0155999 A1
(43) Pub. Date: Jun. 4, 2026

(54) METHOD OF ACQUIRING AN OPERATIONAL CERTIFICATE

(71) Applicant: Landis+Gyr Technology, Inc., Alpharetta, GA (US)

(72) Inventors: Craig CORNWALL, Alpharetta, GA (US); August SCHACK, Alpharetta, GA (US); Roland JOHNSON, Alpharetta, GA (US)

(21) Appl. No.: 18/879,557

(22) PCT Filed: Jul. 20, 2023
(86) PCT No.: PCT/US2023/070570

§ 371 Date: Dec. 27, 2024

Related U.S. Application Data
(60) Provisional application No. 63/368,973, filed on Jul. 20, 2022.

(51) Int. Cl. H04L 9/32; H04L 9/08

(52) U.S. Cl. CPC H04L 9/3263; H04L 9/0825

(57) ABSTRACT

A method of acquiring an operational certificate for an application (140) running on an authorized and/or authenticated host node (130) in a network (100), the method comprising: transmitting, by the application, a request comprising a Certificate Signing Request to a proxy engine (145) running on the authorized and/or authenticated host node; receiving, by the proxy engine, the request, and submitting the Certificate Signing Request to a Certificate Authority (155); signing, by the Certificate Authority, the operational certificate and transmitting a response comprising the signed operational certificate to the proxy engine; and forwarding, by the proxy engine, the signed operational certificate to the application.

### TECHNICAL FIELD OF THE DISCLOSURE

The present disclosure is in the field of operational certificates for devices in networks such as Internet of Things (IoT) networks, and relates in particular to a method of acquiring an operational certificate for an application running on an authorized and/or authenticated host node in a network.

### BACKGROUND

Networked devices, such as IoT devices and Machine-to-Machine (M2M) devices may be capable of communicatively connecting with each other for inter-device communication and/or for interconnecting with other networks, cloud-based devices such as servers, or the internet. In an example, such networked devices may include smart utility meters for electricity, water or gas.

In an example, an IoT system may comprise IoT devices communicatively coupled with one another to exchange data. The IoT system may, for example, include a set of nodes that connect to a network, e.g., the internet or an intranet, either directly or indirectly through one or more additional layers of nodes.

Operations or functions on such IoT devices may require one or more operational certificates to ensure that the IoT device (or a user of the IoT device) is permitted to carry out said operations or functions. Typically, such operational certificates may identify functional and operational limits of the IoT device, such as a time period or expiry time for performing certain functions.

In an IoT system, there may be a need to acquire operational certificates that are signed by an authorized Certificate Authority (CA).

However, in some examples un-trusted or third-party software applications, known as ‘apps’, may be executed on an authorized node within the IoT system. It may be necessary for such software applications to acquire their own operational certificates for secure transport, e.g. to securely communicate with another node, server or device or the like within the IoT system.

For such an un-trusted or third-party software application to acquire its own operational certificate, it may be necessary for a valid certificate of the host device to be shared with the software application in order for the software application to authorize the request with the CA. However, this may require divulgence of information to the software application that may compromise a security of the host or even of the IoT system.

It is therefore desirable to provide means for acquiring an operational certificate for a software application executed on a host device in an IoT or M2M system, without divulging information to the software application that may compromise security.

It is therefore an aim of at least one embodiment of at least one aspect of the present disclosure to obviate or at least mitigate at least one of the above identified shortcomings of the prior art.

### SUMMARY

The present disclosure is in the field of operational certificates for devices in networks such as IoT networks, and relates in particular to a method of acquiring an operational certificate for an application running on an authorized and/or authenticated host node in a network.

According to a first aspect of the disclosure, there is provided a method of acquiring an operational certificate for an application running on an authorized and/or authenticated host node in a network, the method comprising:
transmitting, by the application, a request comprising a Certificate Signing Request (CSR) to a proxy engine running on the authorized and/or authenticated host node;
receiving, by the proxy engine, the request, and submitting the CSR to a Certificate Authority (CA);
signing, by the CA, the operational certificate and transmitting a response comprising the signed operational certificate to the proxy engine; and
forwarding, by the proxy engine, the signed operational certificate to the application.

Advantageously, such a method effectively proxies a request for a CSR for an operational certificate without divulging the details of a signed certificate of the host device, or details of a Public Key Infrastructure (PKI) framework, such as IP address of the CA (Certificate Authority).

In an example IoT environment there may be a need to acquire operational certificates (also known in the art as ‘opcerts’) that are signed by a known and/or authorized CA server. In an environment where there are un-trusted or third party software applications, e.g. ‘apps’, that are running on an authorized node, there may be a need for the software applications to acquire one or more of their own operational certificates for secure transport. The above-described method may address this need.

That is, in a secure ecosystem for one or more software applications and any host system(s) that the one or more software applications may be running on, an authorized host node may use its credentials, e.g. its authorization and/or authentication, to acquire one or more operational certificates on behalf of the one or more software applications.

Furthermore, the disclosed method may reduce a system complexity, because implementation of the method may mitigate a requirement to communicate to a software application details of an infrastructure that may be required for the software application to able to request the operational certificate on its own.

The CA may be an authorized CA server. The CA may be an authorized CA proxy.

A proprietary protocol may be used for transmission, by the application, of the request comprising a Certificate Signing Request (CSR) to the proxy engine running on the authorized and/or authenticated host node.

Prior to receipt of the signed operational certificate, the application may be an untrusted application or application client running on the authorized and/or authenticated host node.

The network may comprise a Public Key infrastructure (PKI) configured for implementing an a priori method of authenticating/authorizing the host node.

That is, the above described signed certificate of the host device may be a so-called “birth certificate”, e.g. a signed certificate issued and loaded into the host device at factory that provides authenticity for that unique host device.

The authentication/authorization of the host node may be based on a signed certificate issued and/or assigned to and/or installed on the host node during production of the host node.

That is, the “birth certificate” may be used as an authentication mechanism to acquire an operational certificate to use for normal secure transport flow operations.

The application may be configured to generate a public/private key pair. The request may comprises the public key for encrypting the response from the CA.

The response from the CA may comprise the operational certificate encrypted using the public key.

The method may comprise using the private key to decrypt the operational certificate encrypted using the public key.

The request may comprise a parameter, e.g. data, indicating a type of operational certificate.

The request may comprise a previous operational certificate.

That is, a payload of the request may comprise a ‘cert type’ indicating one or more types of operational certificate, such as TLS or signing, etc. The payload of the request may comprise the CSR. The payload of the request may comprise one or more previous operational certificates, for example if the request is for a renewal of one or more operational certificates. The payload of the request may comprise the public key used to encrypt the response back with the signed operational certificate.

The proxy engine may be an authenticated certificate manager configured to receive requests from the application requesting the CSR.

That is, the proxy engine may receive the operational certificate request and, using its own authentication, may create a connection to the CA (or CA proxy), and submit the CSR.

The network may be an Internet-of-Things (IoT) network.

According to a second aspect of the disclosure, there is provided a method of authenticating/authorizing an application in an IoT network, the method comprising acquiring, according to the method of any preceding claim, an operational certificate for the application.

Advantageously, the disclosed method may allow software applications running on the host to acquire operational certificates without manually adding authentication permissions to each software application individually, while also securing and/or masking details of any PKI framework.

According to a third aspect of the disclosure, there is provided a computer-readable storage medium comprising instructions which, when executed by a computer on an authorized and/or authenticated host node in a network, cause the computer to:
configure an application to transmit a request comprising a Certificate Signing Request (CSR) to a proxy engine running on the authorized and/or authenticated host node;
configure the proxy engine to receive the request, and submit the CSR to a Certificate Authority (CA);
configure the proxy engine to receive from the CA a response comprising the operational certificate singed by the CA;
configure the proxy engine to forward the signed operational certificate to the application.

According to a fourth aspect of the disclosure, there is provided a node device communicatively coupled to a network, the node device comprising and/or coupled to the computer-readable storage medium of the third aspect.

The node device may be configured as a smart utility meter for metering consumption of electricity, water or gas.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF THE PREFERRED EMBODIMENTS

These and other aspects of the present disclosure will now be described, by way of example only, with reference to the accompanying drawings, wherein:

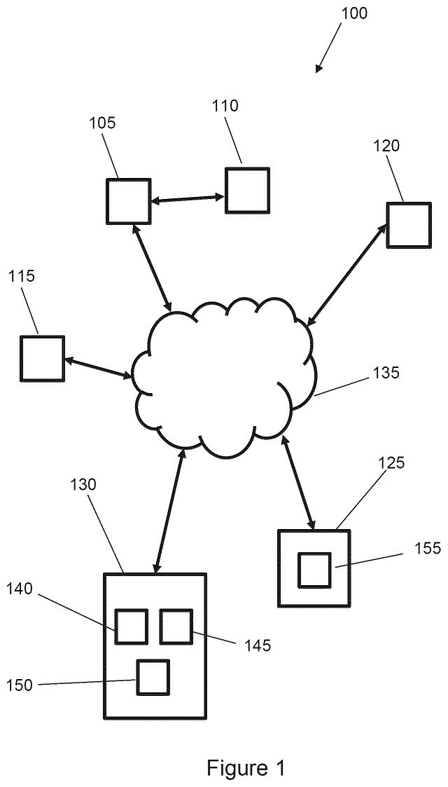

FIG. 1 depicts an example of a network for implementing a method of acquiring an operational certificate, according to an embodiment of the disclosure;

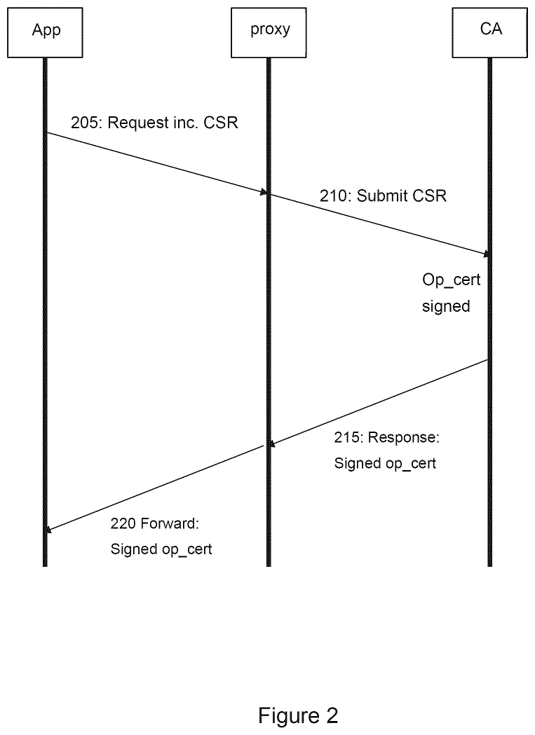

FIG. 2 a sequence diagram corresponding to a method of acquiring an operational certificate, according to an embodiment of the disclosure; and

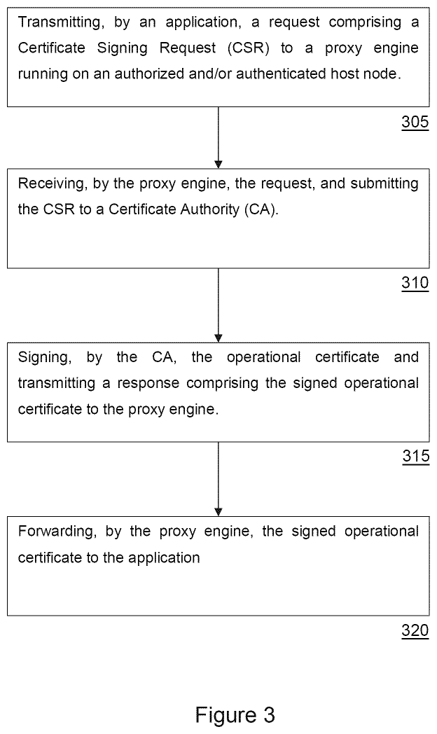

FIG. 3 depicts a flow diagram of the method of acquiring an operational certificate, according to an embodiment of the disclosure.

### DETAILED DESCRIPTION OF THE PREFERRED EMBODIMENTS

FIG. 1 depicts an example of a network 100 for implementing a method of acquiring an operational certificate, according to an embodiment of the disclosure. The network comprises a plurality of nodes 105, 110, 115, 120, 125, 130.

In the example network 100, the plurality of nodes 105, 110, 115, 120, 125, 130 are communicatively coupled to the internet 135. Although the example of FIG. 1 depicts connectivity to the internet 135, in other examples the plurality of nodes 105, 110, 115, 120, 125, 130 may be connected to an intranet. Furthermore, connectively may be through any known medium, such as wirelessly, optically, conductively, via one or more routers or gateways, or the like. That is, it will be understood that FIG. 1 depicts implementation of a network 100 for illustrative purposes, and various other configurations of a network may implement the disclosed invention.

Furthermore, nodes of the network 100 may be indirectly connected to the internet 135, such as node 110 which is connected to the internet 135 via further node 105.

In the example, the network 100 may be an IoT network, e.g. a network 100 wherein the plurality of nodes 105, 110, 115, 120, 125, 130 may be embedded with sensors, software, and other technologies for the purpose of connecting and exchanging data with other devices and systems over the internet.

For example, one or more of the plurality of nodes 105, 110, 115, 120, 125, 130 may be configured as a smart utility meter for metering consumption of electricity, water or gas, and for communicating consumption information over the internet 135 to a utility company and/or pricing information to a consumer.

A first node 130 comprises processing capability for executing one or more software applications. In the example, a software application 140 is run on the first node 130. As such the first node 130 is a host device for the software application 140.

The first node 130 may be authorized and/or authenticated host node in the network 100. That is, the first node 130 may be authorized to communicate over the network 100, such as with one or more other of the plurality of nodes 105, 110, 115, 120, 125, 130 via the internet 135.

The first node 130 may comprise a signed certificate 150 which may be a so-called “birth certificate” as described-above, e.g. a signed certificate issued and loaded into/installed in the first node 130 during production of the first node 130 to provide authenticity for that unique first node 130 in the network 100.

In use, the software application 140 may be an untrusted and/or third party application.

In order for the software application 140 running on the authorized and/or authenticated first node 130 to be able to communicate over the network 100, it may be necessary for the software application 140 to acquire a signed operational certificate.

In use, the software application 140 may be configured to transmit a request comprising a CSR to a proxy engine 145 running on the authorized and/or authenticated first node 130. In examples, a proprietary protocol may be used for transmission, by the software application 140, of the request comprising a Certificate Signing Request (CSR) to the proxy engine 145 running on the authorized and/or authenticated first node 130. The software application 140 may be configured to generate a public/private key pair. The request may comprises the public key.

In some examples, a payload of the request may comprise a ‘cert type’ indicating one or more types of operational certificate, such as TLS or signing, etc. The payload of the request may comprise the CSR. The payload of the request may comprise one or more previous operational certificates, for example if the request is for a renewal of one or more previously issued and/or signed operational certificates. The payload of the request may comprise the public key used to encrypt the response back with the signed operational certificate.

The proxy engine 145 may receive the request and submit the CSR to a Certificate Authority (CA) 155.

For purposes of example only, the CA 155 is depicted as running on a second node 125 coupled to the internet 135. However, it will be understood the this is for example only, and the CA 155 may be implemented on a server, cloud-based device, edge-device or another part of the network 100, including non-depicted parts of the network 100. The CA 155 may be an authorized CA server. The CA 155 may be an authorized CA proxy.

The CA 155 may be configured to sign the operational certificate, and subsequently transmit a response comprising the signed operational certificate to the proxy engine 145. The response from the CA 155 may comprise the operational certificate encrypted using the public key.

The proxy engine 145 may be configured to forward the signed operational certificate to the software application 140.

In some examples, the software application 140 may be configured to use the private key to decrypt the operational certificate encrypted using the public key.

FIG. 2 depicts a sequence diagram corresponding to a method of acquiring an operational certificate, according to an embodiment of the disclosure. The sequence diagram also corresponds to the flow diagram of FIG. 3.

In a first event 205, the software application denoted “app”, which may be the software application 140 of FIG. 1, transmits a request comprising a payload to a proxy engine, denoted ‘proxy’. The proxy engine may be the proxy engine 145 running on the authorized and/or authenticated first node 130 of the network 100 of FIG. 1.

The payload of the request comprises a Certificate Signing Request (CSR). As described above, in other examples, the payload may also comprise one or more of: a ‘cert type’; one or more previous operational certificates; and/or a public key used to encrypt the response back with the signed operational certificate. The first event corresponds to the first step 305 of the flow diagram of FIG. 3.

In a second event 210, corresponding to the second step 310 of the flow diagram of FIG. 3, the proxy engine submits the CSR to a Certificate Authority (CA). The CA may be the CA 155 of the network 100 of FIG. 1.

In a third event 215, corresponding to the third step 315 of the flow diagram of FIG. 3, the CA signs the operational certificate and transmits a response comprising the signed operational certificate to the proxy engine.

In a fourth event 220, corresponding to the fourth step 320 of the flow diagram of FIG. 3, the proxy engine forwards the signed operational certificate to the software application.

Although the disclosure has been described in terms of particular embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

LIST OF REFERENCE NUMERALS

| | |
|---|---|
| 100 | network |
| 105 | node |
| 110 | node |
| 115 | node |
| 120 | node |
| 125 | node |
| 130 | first node |
| 135 | internet |
| 140 | software application |
| 145 | proxy engine |
| 150 | signed certificate |
| 155 | certificate authority |
| 205 | first event |
| 210 | second event |
| 215 | third event |
| 220 | fourth event |
| 305 | first step |
| 310 | second step |
| 315 | third step |
| 320 | fourth step |

1. A method of acquiring an operational certificate for an application running on an
authorized and/or authenticated host node in a network, the method comprising:
transmitting, by the application, a request comprising a Certificate Signing Request (CSR) to a proxy engine running on the authorized and/or authenticated host node;
receiving, by the proxy engine, the request, and submitting the CSR to a Certificate Authority (CA);
signing, by the CA, the operational certificate and transmitting a response comprising the signed operational certificate to the proxy engine;
forwarding, by the proxy engine, the signed operational certificate to the application.

2. The method of claim 1, wherein the CA is an authorized CA server or an authorized CA proxy.

3. The method of claim 1, wherein prior to receipt of the signed operational certificate the application is an untrusted application or application client running on the authorized and/or authenticated host node.

4. The method of claim 1, wherein the network comprises a Public Key infrastructure (PKI) configured for implementing an a priori method of authenticating/authorizing the host node.

5. The method of claim 4, wherein the authentication/authorization of the host node is based on a signed certificate issued and/or assigned to and/or installed on the host node during production of the host node.

6. The method of claim 1, wherein the application is configured to generate a public/private key pair, and wherein the request comprises the public key for encrypting the response from the CA.

7. The method of claim 6, wherein the response from the CA comprises the operational certificate encrypted using the public key.

8. The method of claim 7, comprising using the private key to decrypt the operational certificate encrypted using the public key.

9. The method of claim 1, wherein the request comprises one or more of: a parameter indicating a type of operational certificate; and/or a previous operational certificate.

10. The method of claim 1, wherein the proxy engine is an authenticated certificate manager configured to receive requests from the application requesting the CSR.

11. The method of claim 1, wherein the network is an Internet-of-Things (IoT) network.

12. A method of authenticating/authorizing an application in an IoT network, the method comprising acquiring, according to the method of claim 1, an operational certificate for the application.

13. A computer-readable storage medium comprising instructions which, when executed by a computer on an authorized and/or authenticated host node in a network, cause the computer to:
configure an application to transmit a request comprising a Certificate Signing Request (CSR) to a proxy engine running on the authorized and/or authenticated host node;
configure the proxy engine to receive the request, and submit the CSR to a Certificate Authority (CA);
configure the proxy engine to receive from the CA a response comprising the operational certificate singed by the CA;
configure the proxy engine to forward the signed operational certificate to the application.

14. A node device communicatively coupled to a network, the node device comprising and/or coupled to the computer-readable storage medium of claim 13.

15. The node device of claim 14, configured as a smart utility meter for metering consumption of electricity, water or gas.
